(19) United States
(12) Patent Application Publication
(10) Pub. No.: US 2014/0248803 A1
(43) Pub. Date: Sep. 4, 2014

(54) Coaxial Electrical Connector Assembly

(71) Applicant: 3M INNOVATIVE PROPERTIES COMPANY, St. Paul, MN (US)

(72) Inventors: Richard J. Scherer, Austin, TX (US); Joseph N. Castiglione, Cedar Park, TX (US); Leon D. Schmidt, Cedar Park, TX (US)

(21) Appl. No.: 14/348,909

(22) PCT Filed: Oct. 17, 2012
(86) PCT No.: PCT/US2012/060543

§ 371 Date: Apr. 1, 2014

Related U.S. Application Data
(60) Provisional application No. 61/551,207, filed on Oct. 25, 2011.

(51) Int. Cl. H01R 9/05

(52) U.S. Cl. CPC H01R 9/0515
USPC 439/620.03

(57) ABSTRACT

Example coaxial connector assemblies are described. In one example, a coaxial connector assembly (10) may include first (12) and second (14) connectors that may be securely mated and unmated from each other. When mated, first and second connectors may collectively include a plurality of cable assemblies. Each cable assembly may include a coaxial cable including a center conductor that may be electrically coupled to a pin (20a) within a receptacle when the first and second connectors are mated. Ground contacts may separate neighboring pins and center conducts as well as shield structures to decrease interference between respective cable assemblies.

### TECHNICAL FIELD

The disclosure relates to electrical connectors and electrical connection assemblies.

### BACKGROUND

An electrical connector can allow for the connection of integrated circuits on circuit boards to cables or electronic devices. It is a common practice to connect a cable to a printed circuit board (PCB) by utilizing a plug connector at an end of the cable which is intended for insertion into an opposing mating connector. The mating connector is typically mounted on the PCB, e.g., placed within a housing of an electronic device.

### SUMMARY

In general, the disclosure relates to electrical connectors and electrical connector assemblies. In some examples, the disclosure relates to a coaxial electrical connector assembly. The electrical connector assembly may include first and second electrical connectors that collectively form a plurality of coaxial cable assemblies. Each of the plurality of coaxial connector assemblies may be configured to electrical couple a conductor of a coaxial cable of the first connector with a pin of the second connector when the first and second connectors are mated with each other. In some examples, such a coaxial connector assembly may be used to physically and electrically couple a pin array with an array of coaxial cables, e.g., on the surface of

[symbol]

In one example, the disclosure is directed to a coaxial connector assembly comprising a plurality of cable assemblies, each cable assembly comprising a coaxial cable comprising a conductor surrounded by an insulator surrounded by a first shield; an elongated receptacle receiving the coaxial cable conductor from a first end of the receptacle; a pin having a first end portion inserted into the receptacle from an opposing second end of the receptacle and making electrical contact with the coaxial cable conductor, a second end portion, and a step portion connecting and stepping down from the first end portion to the second end portion; a first insulative housing surrounding the pin; a second shield surrounding the pin and being electrically isolated from the pin by the first insulative housing, the second shield electrically contacting the first shield of the coaxial cable; and first and second conductive ground contacts on either side of the cable assembly, each ground contact comprising a body portion terminating at a contact portion and making electrical contact with the second shield, such that when viewed from a side view of the connector assembly, the body portion covers the step portion of the pin, the portion of the first end portion of the pin that is not within the receptacle, and at least a portion of the receptacle, the second end portion of the pin and the contact portion of the ground contact being configured to contact corresponding contacts on a board.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIGS. 1-22 are conceptual diagrams illustrating various aspects of an example electrical connector assembly.

### DETAILED DESCRIPTION

In general, the disclosure relates to electrical connectors and electrical connector assemblies. In some examples, the disclosure relates to a coaxial electrical connector assembly. The electrical connector assembly may include first and second electrical connectors that collectively form a plurality of coaxial cable assemblies. Each of the plurality of coaxial connector assemblies may be configured to electrically couple a center conductor of a coaxial cable of the first connector with a pin of the second connector when the first and second connectors are mated with each other. In some examples, such a coaxial connector assembly may be used to physically and electrically couple a pin array with an array of coaxial cables, e.g., on the surface of a printed circuit board (PCB), when the first and second connectors are mated with each other.

In some cases, board-mount RF coaxial cable connectors include a center conductor for signal and four grounding points extending radially from the signal conductor. RF coaxial connectors may be bulky and require finger spacing to twist, one at a time, a connector by hand to mate the connector with a corresponding connector mounted on the surface of a PCB. Additionally, cable-to-board coaxial connector interfaces may emulate a conductor in a tube to a like device mounted on a PCB, where the coaxial cable extends substantially perpendicular to the surface of the PCB unless the assembly is mounted on the edge of the board. Some efforts have been made to provide a smaller form factor in a push/pull type connector interface, but such configurations may lead to rocking of the interface, causing fretting and RF leakage due to unsustainable mechanical sealing. In addition to technical restrictions for providing a robust small form factor board-mount RF coaxial cable connector assemblies, some RF coaxial cable components have been industry standard allowing reverse engineering of relatively complex circuit board printed wiring assemblies.

In accordance with one or more examples of the disclosure, coaxial cable connector assemblies including a plurality of cable assemblies are described. Each of the plurality of coaxial connector assemblies may be configured physically and electrically couple a pin of a pin array with a center conductor of an array of coaxial cables, e.g., on the surface of a PCB. Ground contacts may separate pins and center conductors of neighboring cable assemblies when the pins and center conductors are electrically coupled to each other to provide for increased isolation between neighboring assemblies.

In some examples, a coaxial cable connector assembly may include non-standard board-mount components with a non-standard design cable assembly. In some example, the non-standard cable assembly may include one or more non -radio grade coaxial cable. Furthermore, in some examples, a coaxial connector assembly may be configured such that the connector interface is also relatively low profile. For examples, in the case of a board mount, the insertion path of the coaxial cables in the connection assembly may be substantially parallel to the surface of a PCB. Additionally, a coaxial connection assembly may include ground contacts rising from the PCB to mate to a 360 degree shield surrounding a receptacle used to couple a signal center conductor of a coaxial cable with a pin of a pin array.

In some examples, examples of the disclosure may allow a designer to closely space at low profile, high bandwidth signals for a separable interface to a coaxial cable transmission line for routing to another device or location. The cable connector of the connector assembly may be a high density shielded controlled impedance (HDSCI) for a coaxial cable, which may also be coupled to a like device or industry standard device unless, e.g., soldered direct to a circuit board. The board mounted electrical connector of the connector assembly may include a right angle signal pin array and right angle ground shields to lower crosstalk and maintain electrical impedance stability, e.g., performing at approximately 6 GHz or more at approximately −3 dB. In some examples, the pins of the pin array may be configured to be surface mounted, e.g., on the surface of a PCB. Conversely, in some examples, the right angle ground shields may be configured to be through-hole mounted, e.g., through all or a portion of a PCB.

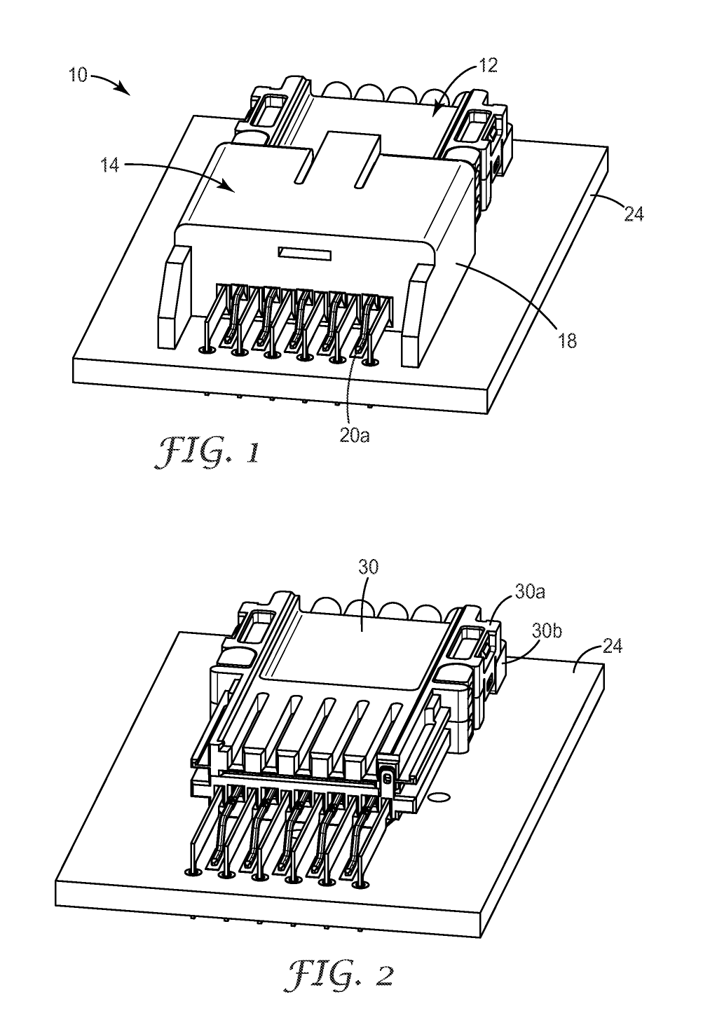

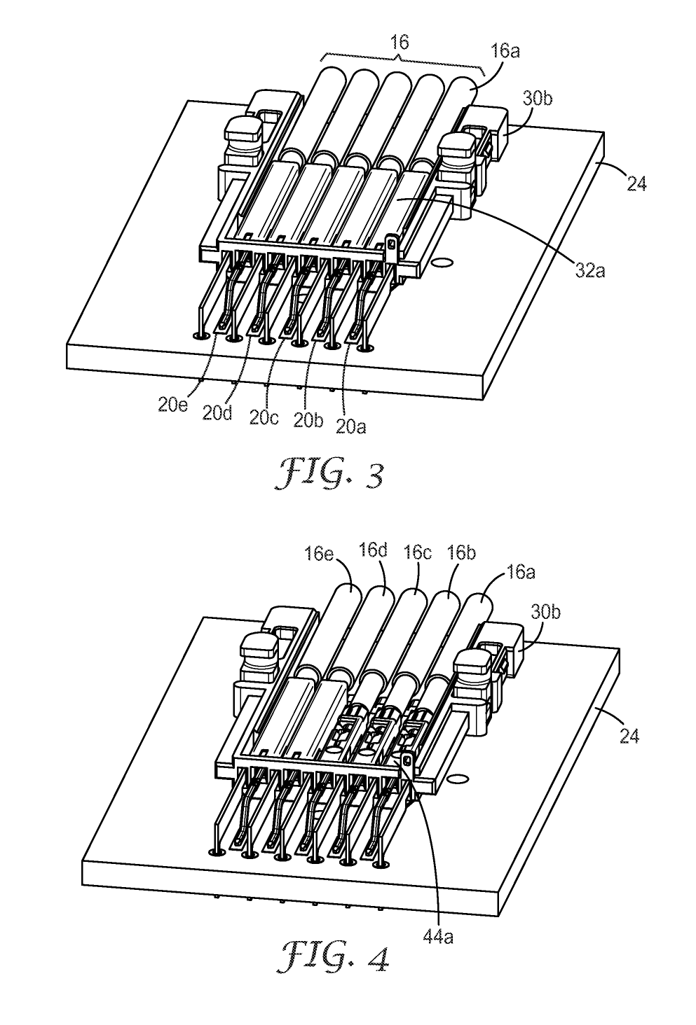

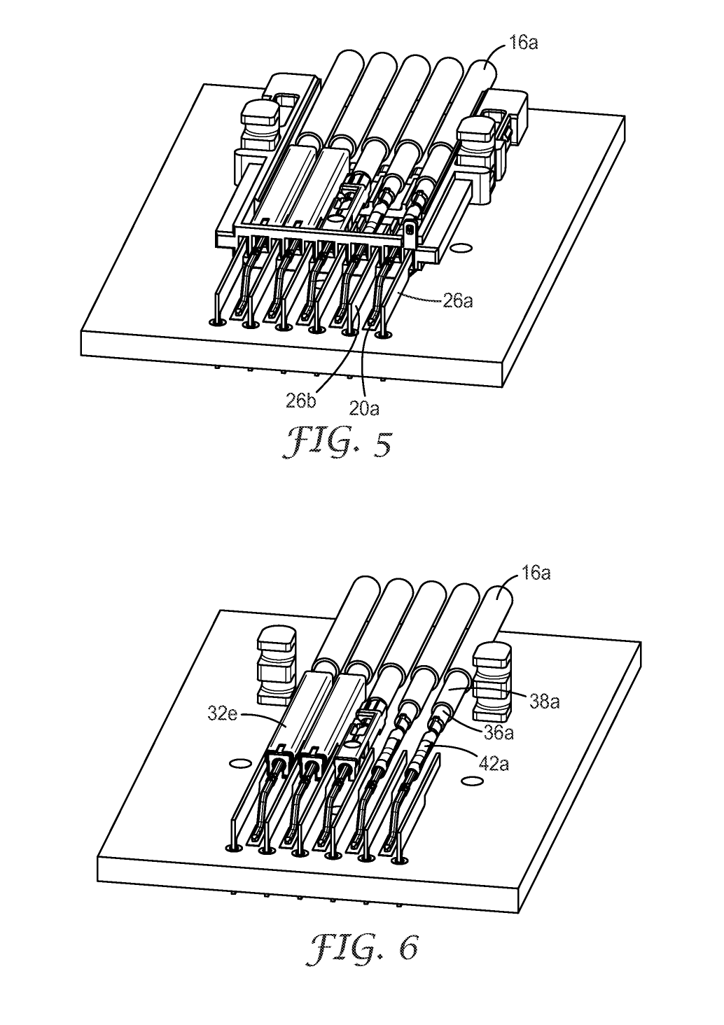

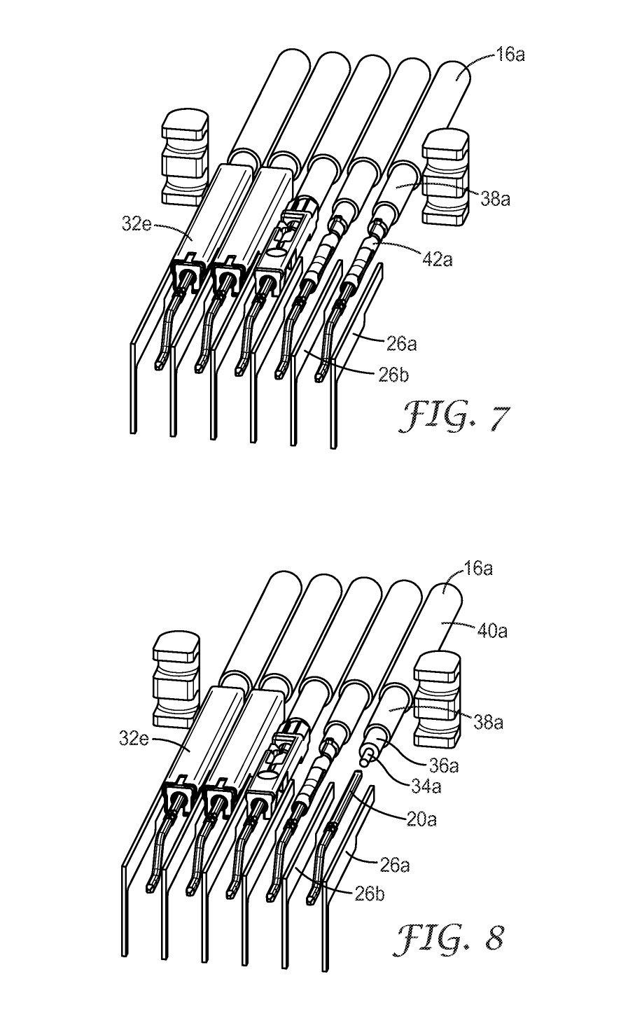

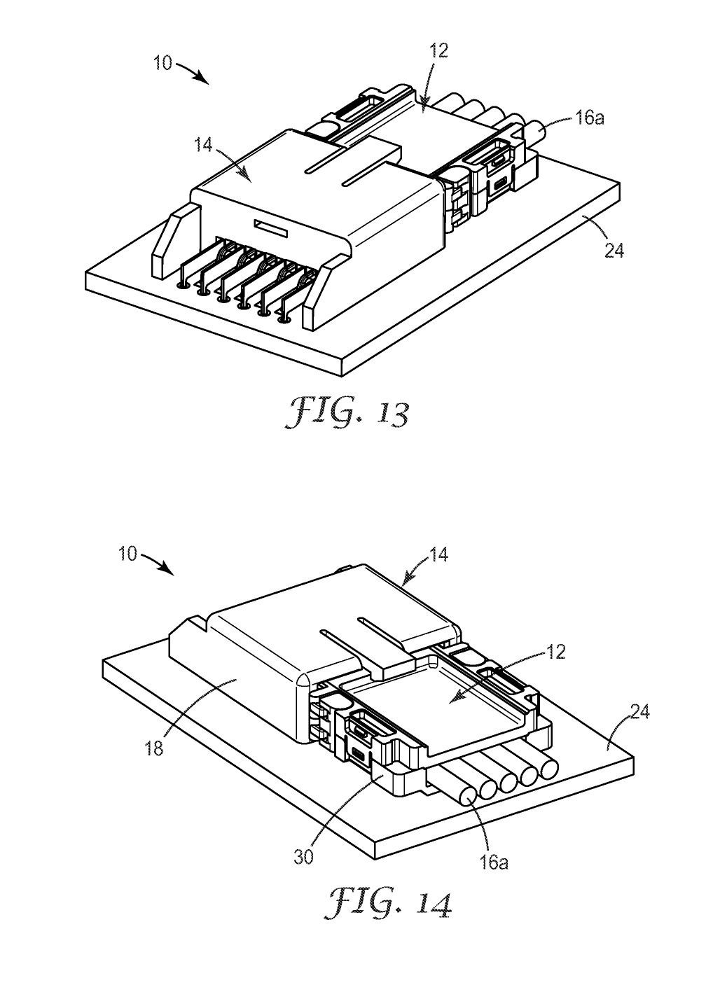

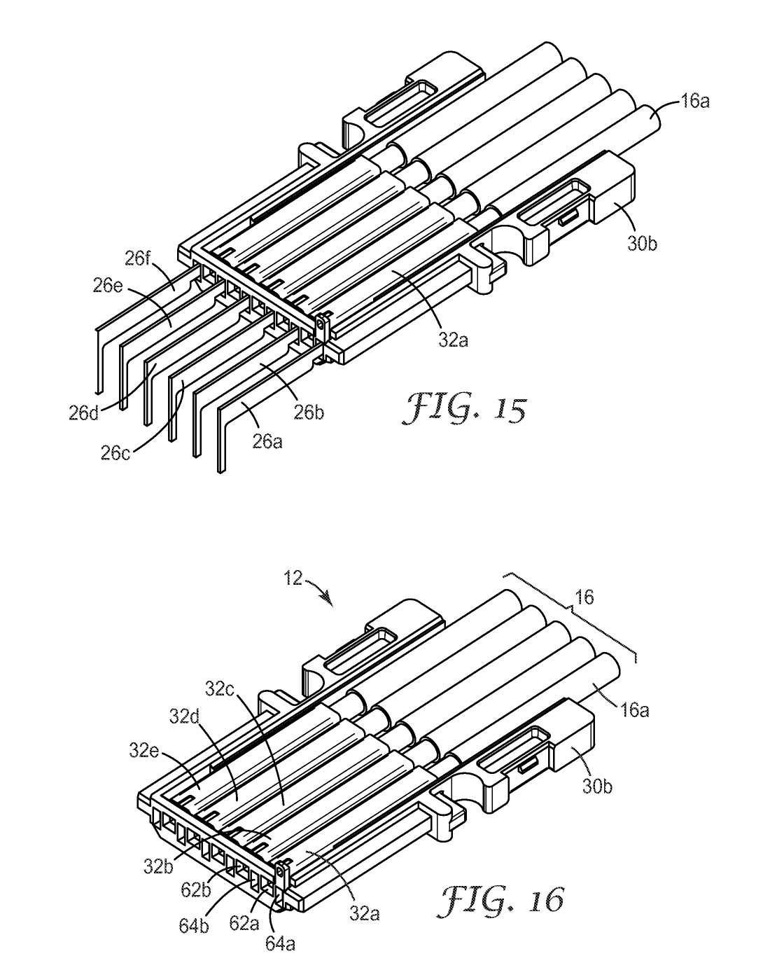

FIGS. 1-22 are conceptual diagrams illustrating various aspects of an example coaxial connector assembly 10. For ease of illustrating, like features of coaxial connector assembly 10 are similarly numbered throughout FIGS. 1-22. As will described below, coaxial connector assembly 10 includes first connector 12 and second connector 14 configured to securely mate with each other to physically couple first and second connectors 12, 14 to each other as well as electrically couple conductors of the respective connectors to each other. First connector 12 may be configured as a male (or plug) connector and second connector 14 may be configured as a female (or receptacle) connector. First connector 12 may include a plurality of coaxial cables 16 (individually referred to as cables 16a-e) each including a center conductors of plurality of center conductors 34 (individually referred to as center conductors 34a-e) which may be electrically coupled to one of a plurality of pins 20 (individually referred to as pins 20a-e) when first connector 12 is mated with second connector 14. For example, FIG. 8, as labeled, shows coaxial cable 16a including center conductor 34a as well as pin 20a of second connector 14.

For ease of illustration, example cable assemblies of the disclosure will primarily be described with regard to the example cable assembly including components denoted by the letter “a”, e.g., cable 16a, pin 20a, center conductor 34a, and the like. However, coaxial cable connector assembly 10 may include a plurality of such cable assemblies, and it is understood that the particular cable assembly and components thereof may be representative of other cable assemblies of coaxial cable connector assembly 10. For example, coaxial cable connector assembly 10 may include a plurality of cable assemblies that are substantially the same or similar to that of the cable assembly described with reference to the components denoted by the letter “a” throughout. However, other example cable assemblies are contemplated.

As shown in FIG. 1, second connector 14 may be surface mounted on PCB 24 and coaxial connector assembly 10 may be referred in some examples as a cable-to-board connector assembly. First connector 30 may include outer housing 30 including top cover 30a and bottom cover 30b. FIG. 16 is a conceptual diagram illustrating first connector 12 unmated from second connector 14 and with top cover 30a of housing 30 removed. As shown, top cover 30a and bottom cover 30b may be mechanically coupled to form housing 30 that at least partially encloses plurality of shield structures 32 (individually referred to as shield structures 32a-e) and the ends of plurality of coaxial cables 16. Each shield structure of plurality of shield structures 32 includes one of a plurality of receptacles 42 (individually referred to as receptacles 42a-e). As will be described below, in some examples, receptacle 42a may be formed of an electrical conductive material that allows center conductor 34a of cable 16a to be electrically coupled to pin 20a via receptacle 42a. For example, receptacle 42a may be formed of phosphor bronze or beryllium copper. In some examples, contact areas of receptacle 42a may be plated with gold over nickel to enhance the longevity of the connection.

As will be apparent from the following description, coaxial connector assembly 10 may include a plurality of cable assemblies. Housing 30 of first connector 12, in combination with housing 18 of second connector 14, may define a plurality of slots configured to secure the plurality of cable assemblies described herein within the slots. In some examples, bottom portion 30b of housing 30 may define a plurality of slots configured to receive respective cable assemblies, while top portion 30a may define a substantially flat inner surface 76 (FIG. 10) to cover the cable assemblies in received in the slots. However, other housing configurations are contemplated.

As shown in FIG. 8, coaxial cable 16a includes center conductor 34a surrounded by insulator layer 36a, shield layer 38a, and outer layer 40a. Insulator layer 36a electrically insulates center conductor 34a from shield layer 38, and shield layer 38a provides shielding of center conductor 34a from external electric and/or magnetic fields to reduce interference. For examples, to shield center conductor 34a, shield layer 38a may be kept at ground potential while a voltage is applied to the center conductor 34a to transmit electrical signals. Center conductor 34a may be formed of any suitable conductive material including, e.g., copper or steel. In some examples, center conductor 34a may be silver plated. Insulator layer 36a may be formed of any suitable insulative material including, e.g., polyethylene, polytetrafluorethylene, fluorinated ethylene propylene, or other low dielectric constant material. Shield layer 38a may be formed of any suitable shielding material including, e.g., silver plated copper (for relative how speed cables), tin plated copper (for lesser performance applications), or may be a foil coated plastic such as Mylar. Outer layer 40a may be formed of any suitable material including, e.g., fluorinated ethylene propylene or polyvinyl chloride (e.g., for flame retardant purposes). Although not shown, the other end of coaxial cable 16 may be coupled, for example, to another connector substantially similar to that described herein or an industry standard coaxial connector, such as, e.g., a SMA, SMB, BNC connector or the like, and may be used to transmit signals via conductor 34 of coaxial cable 16 and pin 18 of coaxial connector assembly 10, for example, in a shielded, compact, and low profile manner In some examples, the transmitted signals may include high bandwidth signals, e.g., between approximately 1 megahertz (Mhz) and approximately 1 Ghz. In some examples, the transmitted signals may greater than approximately 0.3 Ghz or greater than approximately 1 Ghz. In some examples, coaxial cable 16a may comprise a non-radio grade coaxial cable or a radio grade coaxial cable.

Plurality of coaxial cables 16 and plurality of shield structures 32 may each aligned in a row along substantially the same plane. An end portion of center conductor 34a extends into an end of receptacle 42a. Similarly, an end portion of pin 20a may extend into the opposite end of receptacle 42a when first connector 12 is mated to second connector 14. As noted above, when first connector 12 and second connector 14 are mated, center conductor 34a and pin 20a may be electrically coupled to each other via receptacle 42a. In some examples, pin 20a and center conductor 34a may be in direct contact with each other within receptacle 42a. In other examples, while not in direct contact, pin 20a and center conductor 34a may each be in contact with a portion of receptacle 42a to electrically couple pin 20a and center conductor 34a when first connector 12 is mated with second connector 14. In the examples shown, receptacle 42a has an elongated and tubular shape although other shapes are contemplated. While examples are primarily shown with cables 16 filling each slot in the row of coaxial connector assembly 10, in other examples, some slots may be empty, e.g., to allow for increased bandwidth and lower cross-talk, such as, in a clock cable application. Shield structure 32a may shield center conductor 34a and pin 20a within receptacle from electric and/or magnetic fields to reduce external interference in the signals conducted through center conductor 34a and pin 20a. Additionally, shield structure 32a may confine electric and magnetic fields generated as a result of the transmission of signals through center conductor 34a and pin 20a. Similar to that described above, to shield pin 20a and center conductor 34a, shield structure 32a may be kept at ground potential while a voltage is applied through pin 20a and center conductor 34a to transmit electrical signals. In this manner, the crosstalk interference among adjacent cable assemblies of coaxial connector assembly 10 may be reduced, and allow for tighter packing of coaxial cables 16 in connector 10. Shield structure 32a may be formed of any suitable shielding material including, e.g., phosphor bronze or beryllium copper. In some examples, shield structure 32a may be formed of brass (e.g., if ground contacts 70 and 72, described below, are not present). In some examples, gold plating in the contact areas of shield structure 32a may enhance contact life. Soldered areas of shield structure 32a may be plated with tin, tin-lead, or gold.

First connector 12 may also include plurality of insulator housings 44 (individually referred to as insulator housings 44a-e) that are at least partially surrounded by respective shield structures 32. Insulator housing 44a physically separates and electrically insulates receptacle 42a and/or center conductor 34a from shield structure 32a. Furthermore, when first connector 12 is mated with second connector 14, insulator housing 44a surrounds a portion of pin 20a, and physically separates and electrically insulates pin 20a from shield structure 32a. Insulator housing 44a may be formed of any suitable insulative material including, e.g., liquid crystal polymer or other low dielectric constant material.

FIG. 22 is a conceptual diagram illustrating second connector 14 mounted on a surface of PCB 24 without first connector 12 of coaxial connector assembly 10. Second connector 14 may be mounted on the surface of PCB 24 using any suitable technique. Second connector 14 may include outer housing 22 that at least partially encloses plurality of pins 20 and plurality of conductive ground contacts 26 (individually referred to as ground contacts 26a-f). Plurality of pins 20 may be interleaved with plurality of ground contacts 26 to form a row alternating between respective pins 20 and ground contacts 26. Plurality of ground contacts 26 includes one more ground contact than the number of individual pins of pin array 20 such that both ends of the row of pins and ground contacts is a ground contact.

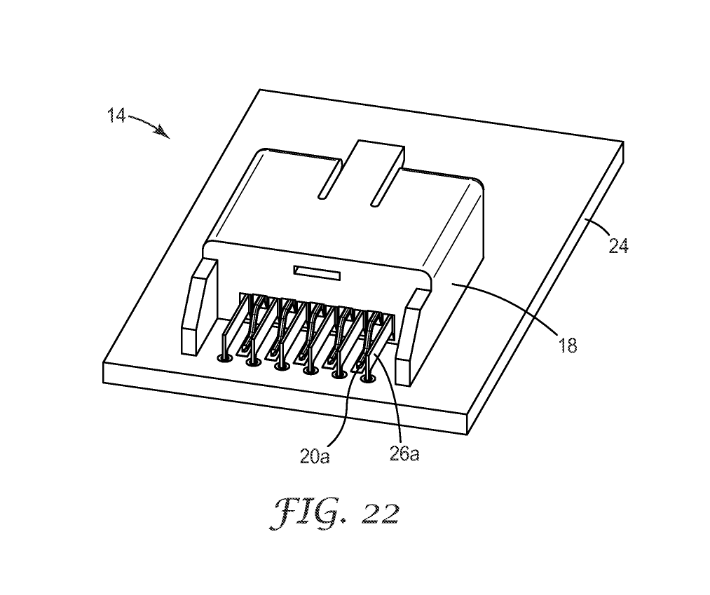

FIGS. 20 and 21 are conceptual diagrams that illustrate cavity 26 formed by outer housing 22. As shown, a first end portion 44a of pin 20a extends through a wall of outer housing 22 into cavity 26, while a second end portion 48a of pin 20a extends out of the opposite side of outer housing 22. Similarly, first end portions 46a, 46b of ground contacts 26a, 26b, respectively, (not shown in FIGS. 20 and 21), extends through a wall of outer housing 22 into cavity 26, while second end portions 52a, 52b of ground contacts 26a, 26b, respectively, extend out of the opposite side of outer housing 22 .

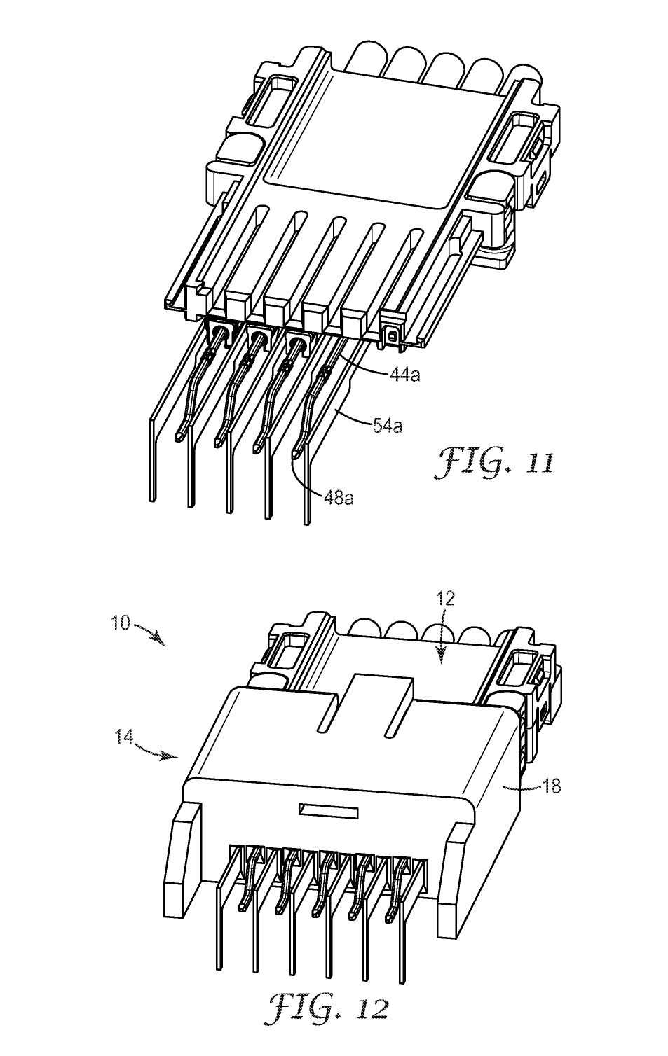

As shown in FIG. 11, for example, second end portion 48a of pin 26a is connected to first end portion 44a via step portion 54a. Such a configuration allows first end portion 44a to extend along a path substantially parallel and above the surface of PCB 24 when second connector 14 is surface mounted on PCB 24 while allowing second end portion to be nearer the surface or on the surface of PCB 24. In some examples, second end portion 48a may be surface mounted on PCB 24, e.g., as shown in FIGS. 1 and 2. In other examples, second end portion 48a may be through-hole mounted on PCB 24. Similarly, ground contacts 26a and 26b may be configured to include extensions 56a and 56b, respectively, which extend from body portions 58a and 56b, respectively, in a non-parallel direction. In some examples, extension 56a and 56b may allow ground contacts 26a and 26b to be through-hole mounted on PCB 24 with body portions 58a and 58b posited above the surface of PCB 24. In other examples, extension 56a and 56b may allow ground contacts 26a and 26b to be surface mounted on PCB 24. In some examples, extension 56a and 56b may extend at a substantially right angle from that of body portions 58a and 58b. In general, for a board mount configuration, second end portion 48a of pin 20a and contact portion 56a (also referred to as extension 56a) of ground contact 26a may be configured to contact corresponding contacts on PCB 24.

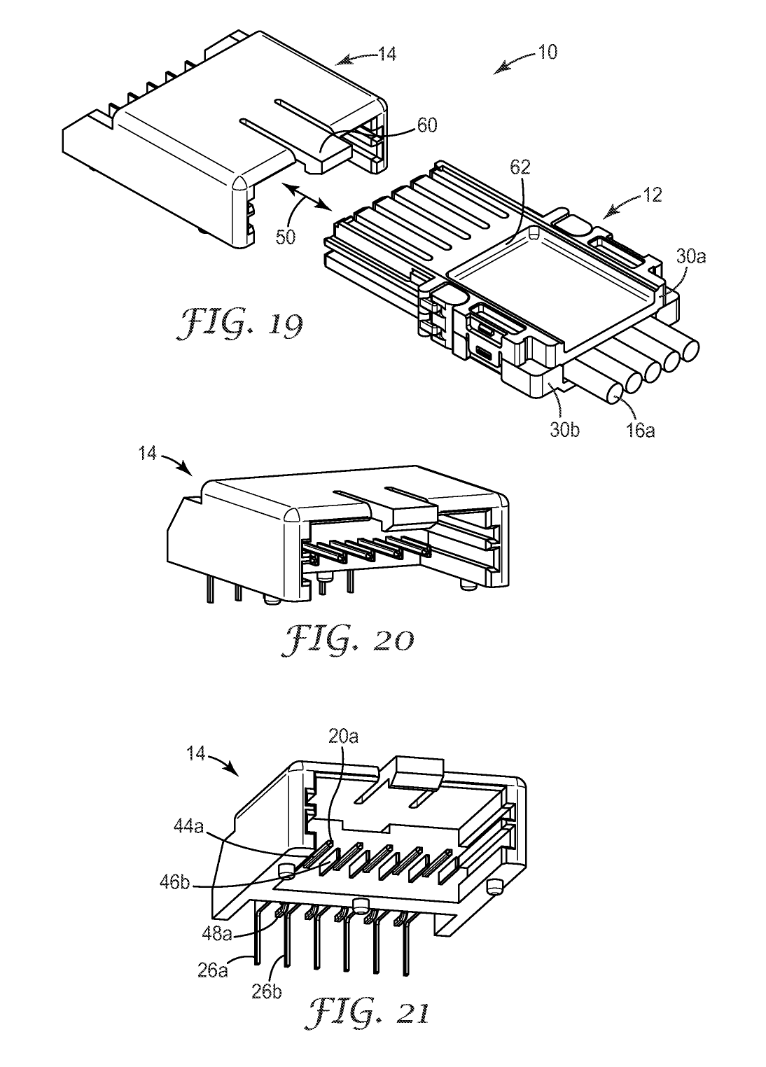

FIG. 19 is a conceptual diagram illustrating first connector 12 unmated from second connector 14. Second connector 14 may be configured to define an insertion path 50 such that first connector 12 may be mated to second connector 14 with respective center conductors 18 plurality of coaxial cables 16 being substantially perpendicular to the surface of PCB 16, e.g., rather than being substantially perpendicular to the surface of PCB 16. Second connector 14 includes latch 60 which engages edge 62 when first connector 12 and second connector 14 when mated with each other to securely mate first connector 12 and second connector 14. To be un-mated, latch 60 must be lifted over edge 62 of first connector 12 while first connector 12 is slid away from second connector 14 along path 50.

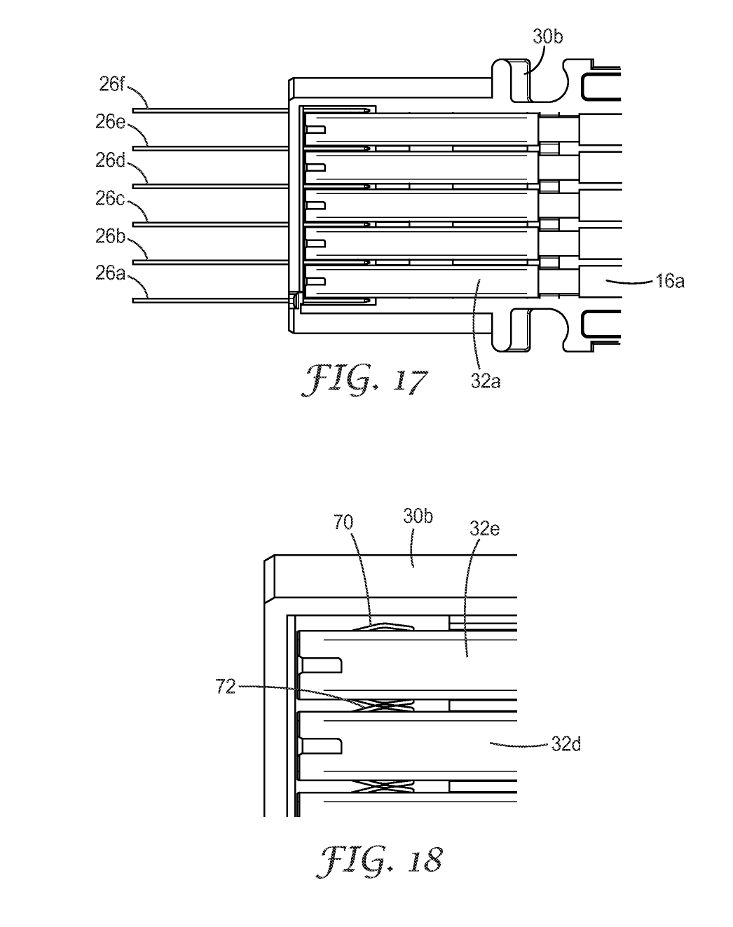

As shown in FIG. 16, for example, bottom housing 30b of first connector 12 may define plurality of first opening 62 (individually referred to as first openings 62a-e) corresponding to pins 20a-f. When second connector 14 is mated with first connector 12, a first end portion 28a of pin 20a may extend through opening 62a into receptacle 42a to be electrically coupled to center conductor 34a of coaxial cable 16a. Likewise, bottom housing 30b of first connector 12 may define plurality of second openings 64 (individually referred to as second openings 64a-f) corresponding to ground contacts 26a-f). When second connector 14 is mated with first connector 12, first end portions 46a and 46b of ground contacts 26a and 26b may extend through openings 64a and 64a, respectively, on either side of pin 20a to engage corresponding ground contacts of shield structure 32a. FIG. 17 is a conceptual diagram illustrating a top view of ground contacts 26a-f inserted within second openings 26a-f and interleaved between shield structures 32a. FIG. 18 is a conceptual diagram showing a magnified top view of shield structure 32e including ground contacts 70 and 72 on either side of shield structure 32e. When first and second connectors 12 and 14 are mated, ground contacts 26f and 26e are electrically coupled to shield structure 32e. Collectively, when first and second connectors 12 are mated, plurality of ground contacts 26 are electrically coupled to plurality of shield structures 32. In such a configuration, the electrical coupling may control electrical impedance and/or reduce crosstalk within assembly 10.

As shown in FIG. 16, in some examples, plurality of second openings 64 may be longer than plurality of first openings 62. When mated, plurality of second openings 64 each holds a corresponding one of plurality of ground contacts 26 with a portion of the ground contacts 26 extending outside housings 18 and 30. Similarly, when mated, plurality of first openings 62 each holds a corresponding one of plurality of pins 20 with step portions 54 and second portions 48a of pins 20 extending outside housings 18 and 30.

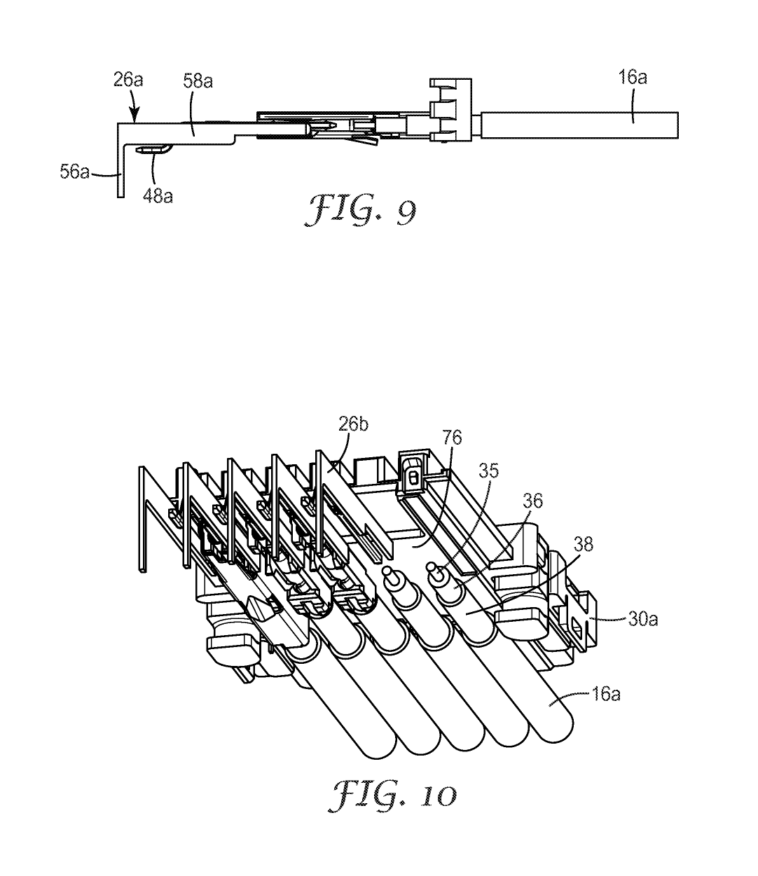

FIG. 9 is a conceptual diagram illustrating a side view of ground contact 26a representative of when first connector 12 is mated with second connector 14. As shown in FIG. 9, when mated, body portion 58a of ground contact 26a covers step portion 54a of pin 20a, the portion of first end portion 44a of pin 20a that is not within receptacle 42a, and at least a portion of receptacle 42a. In some examples, when viewed from side, body portion 58a of ground contact 26a does not cover second end portion 48a of pin 20a while in other examples, body portion 58a of ground contact 26a does cover second end portion 48a of pin 20a. In some example, cross-talk and EMI in assembly 10 may be reduced by covering such portions with ground contact 26a, which may increase the maximum bandwidth capability.

Item 1 is a coaxial connector assembly comprising a plurality of cable assemblies, each cable assembly comprising:

a coaxial cable comprising a conductor surrounded by an insulator surrounded by a first shield;

an elongated receptacle receiving the coaxial cable conductor from a first end of the receptacle;

a pin having a first end portion inserted into the receptacle from an opposing second end of the receptacle and making electrical contact with the coaxial cable conductor, a second end portion, and a step portion connecting and stepping down from the first end portion to the second end portion;

a first insulative housing surrounding the pin;

a second shield surrounding the pin and being electrically isolated from the pin by the first insulative housing, the second shield electrically contacting the first shield of the coaxial cable; and

first and second conductive ground contacts on either side of the cable assembly, each ground contact comprising a body portion terminating at a contact portion and making electrical contact with the second shield, such that when viewed from a side view of the connector assembly, the body portion covers the step portion of the pin, the portion of the first end portion of the pin that is not within the receptacle, and at least a portion of the receptacle, wherein the second end portion of the pin and the contact portion of the ground contact are configured to contact corresponding contacts on a board.

Item 2 is the coaxial connector assembly of item 1, wherein the plurality of cable assemblies form a row of cable assemblies.

Item 3 is the coaxial connector assembly of item 1, wherein the elongated receptacle is electrically conductive.

Item 4 is the coaxial connector assembly of item 1, wherein the second end portions of the pins are configured to be surface mounted.

Item 5 is the coaxial connector assembly of item 1, wherein the contact portions of the conductive ground contacts are configured to be through-hole mounted.

Item 6 is the coaxial connector assembly of item 1, wherein the first and second conductive ground contacts are discrete contacts.

Item 7 is the coaxial connector assembly of item 1, such that when viewed a side view of the connector assembly, the body portion of the ground contact does not cover the second end portion of the pin.

Item 8 is the coaxial connector assembly of item 1, such that when viewed a side view of the connector assembly, the body portion of the ground contact covers the second end portion of the pin.

Item 9 is the coaxial connector assembly of item 1, further comprising a housing securing the plurality of cable assemblies within a corresponding plurality of slots.

Item 10 is the coaxial connector assembly of item 9, wherein the housing comprises alternating longer and shorter openings, each longer opening holding a corresponding conductive ground contact with the contact portion of the conductive ground contact extending to the outside of the housing, each shorter opening holding a corresponding pin with the step portion and second end portion of the pin extending to the outside of the housing.

Item 11 is the coaxial connector assembly of item 9, wherein the housing comprises a top portion having a substantially flat inner surface, and a bottom portion comprising the plurality of slots.

Various embodiments of the invention have been described. These and other embodiments are within the scope of the following claims.

1. A coaxial connector assembly comprising a plurality of cable assemblies, each cable assembly comprising:
a coaxial cable comprising a conductor surrounded by an insulator surrounded by a first shield;
an elongated receptacle receiving the coaxial cable conductor from a first end of the receptacle;
a pin having a first end portion inserted into the receptacle from an opposing second end of the receptacle and making electrical contact with the coaxial cable conductor, a second end portion, and a step portion connecting and stepping down from the first end portion to the second end portion;
a first insulative housing surrounding the pin;
a second shield surrounding the pin and being electrically isolated from the pin by the first insulative housing, the second shield electrically contacting the first shield of the coaxial cable; and
first and second conductive ground contacts on either side of the cable assembly, each ground contact comprising a body portion terminating at a contact portion and making electrical contact with the second shield, such that when viewed from a side view of the connector assembly, the body portion covers the step portion of the pin, the portion of the first end portion of the pin that is not within the receptacle, and at least a portion of the receptacle, wherein the second end portion of the pin and the contact portion of the ground contact are configured to contact corresponding contacts on a board.

2. The coaxial connector assembly of claim 1, wherein the plurality of cable assemblies form a row of cable assemblies.

3. The coaxial connector assembly of claim 1, wherein the elongated receptacle is electrically conductive.

4. The coaxial connector assembly of claim 1, wherein the second end portions of the pins are configured to be surface mounted.

5. The coaxial connector assembly of claim 1, wherein the contact portions of the conductive ground contacts are configured to be through-hole mounted.

6. The coaxial connector assembly of claim 1, wherein the first and second conductive ground contacts are discrete contacts.

7. The coaxial connector assembly of claim 1, such that when viewed a side view of the connector assembly, the body portion of the ground contact does not cover the second end portion of the pin.

8. The coaxial connector assembly of claim 1, such that when viewed a side view of the connector assembly, the body portion of the ground contact covers the second end portion of the pin.

9. The coaxial connector assembly of claim 1, further comprising a housing securing the plurality of cable assemblies within a corresponding plurality of slots.

10. The coaxial connector assembly of claim 9, wherein the housing comprises alternating longer and shorter openings, each longer opening holding a corresponding conductive ground contact with the contact portion of the conductive ground contact extending to the outside of the housing, each shorter opening holding a corresponding pin with the step portion and second end portion of the pin extending to the outside of the housing.

11. The coaxial connector assembly of claim 9, wherein the housing comprising a top portion having a substantially flat inner surface, and a bottom portion comprising the plurality of slots.
